(19) United States
(12) Patent Application Publication
(10) Pub. No.: US 2022/0374396 A1
(43) Pub. Date: Nov. 24, 2022

(54) DISPLAY MOUNT INTERFACESMANAGING ACCESS TO FILE-BASED DATABASE

(71) Applicant: HEWLETT-PACKARD DEVELOPMENT COMPANY, L.P., Spring, TX (US)

(72) Inventors: Jiahao Zhou, Shanghai (CN); Shu-Wu Shi, Shanghai (CN); Xiao-Lu Zhang, Shanghai (CN)

(73) Assignee: HEWLETT-PACKARD DEVELOPMENT COMPANY, L.P., Spring, TX (US)

(21) Appl. No.: 17/326,992

(22) Filed: May 21, 2021

(51) Int. Cl. G06F 16/176; G06F 16/16; G06F 16/182

(52) U.S. Cl. CPC G06F 16/1774; G06F 16/168; G06F 16/1824

(57) ABSTRACT

According to aspects of the present disclosure, there are provided methods and computer program product for accessing a file-based database, the method comprising receiving, at a first process of a multi-process application, a request from a second process of the multi-process application to perform an operation on a file-based database; in response to receiving the request at the first process, beginning execution of a database access thread to perform the requested operation on the file-based database, and providing, by the first process, a result of the requested operation to the second process, and wherein if the requested operation is a write access to the file-based database, limiting to one a number of threads executing to perform operations on the file-based database while the database access thread to perform the write access is executing.

### BACKGROUND

Computer applications are often provided with a means for storing and using structured data. In order to simplify the process of developing and building desktop or device applications, file-based databases have been developed as a data service solution that can be embedded within an application to provide a reliable way to store and retrieve application data. The file-based database can provide most functionalities as would be present with a relational database. However, file-based databases may be less flexible and may present challenges when accessed by multiple entities concurrently.

### BRIEF INTRODUCTION OF THE DRAWINGS

Examples are further described hereinafter with reference to the accompanying drawings, in which:

FIG. 1 illustrates an example readers-writers lock mechanism for controlling access to a file-based database;

FIG. 2 illustrates an example queue mechanism for controlling access to a file-based database;

FIG. 3 illustrates a multi-process application according to an example of the disclosure;

FIG. 4 illustrates a method of controlling access to a file-based database according to an example of the disclosure;

FIG. 5 is a sequence diagram illustrating a method of controlling access to a file-based database according to an example of the disclosure;

FIG. 6 illustrates a method performed by an execution thread according to an example of the disclosure; and

FIG. 7 is a schematic block diagram of a computer system according to an example of the disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Further, reference in the specification to “a”, “an” or similar language in relation to a particular feature, structure or characteristic described means a single feature/structure/characteristic or at least one feature/structure/characteristic. Thus, this wording should not be construed as limiting in its use.

File-based databases have been developed to provide reliable and lightweight solutions to the storage of structured data in an application. By embedding the file-based database within the application, a separate database deployment when installing the application may be avoided. Furthermore, this approach has been found to provide a lightweight way, i.e. having low processing and memory requirements, to implement database functionality in an application and as such may be particularly applicable to mobile and IoT devices having limited capabilities, as well as more traditional desktop applications.

An example of a file-based database is an SQLite database. Functions of the SQLite database may be provided in a library that can be compiled or linked into the application and may allow the application to access a file-based database according to the Structured Query Language (SQL) standard. SQLite has been widely adopted, is available on many different platforms, and has been used to provide database services for data access to a disk file format embedded in many desktop applications such as version control systems, financial analysis tools, media cataloging and editing suites, computer aided design (CAD) packages, etc.

However, some file-based databases, including SQLite, are known to have a limitation that only one active write access may be performed on the file-based database at one time. While a write access is being performed on the file-based database, the whole file may be locked to any other read or write access attempts leading to blocking of any other attempted accesses.

Many applications comprise multiple threads of execution or multiple processes, which may themselves have multiple threads. A thread is a component of a process and multiple threads may exists within one process. Threads of a process may execute concurrently and share resources such as memory and address space. As threads within a process share resources, communication and context switching between threads of a process can be achieved quickly.

In contrast, processes are larger units of code that can contain multiple threads. Processes are often independent and do not share resources such as memory with other processes. Interactions and communication between processes is performed though system-provided inter-process communication channels. However, due to the greater isolation provided between processes than between threads, while an illegal operation performed by one thread of a multi-thread process can crash the entire process, an illegal operation performed by one process of a multi-process application will not directly cause other processes of the multi-process application to crash. This property may be used, for example, to provide isolation between webpages run in different tabs of a browser application by executing each tab as a separate process.

In the case that multiple threads of a multi-threaded process attempt concurrent accesses to the file-based database, the limitation that any one active writer to the database locks the whole file may lead to errors if write accesses are not carefully managed. Such errors may not always repeat or may be in the form of race conditions (who writes first) resulting in errors that may be difficult to trace. This may increase the cost of developing an application to handle concurrent accesses and/or make the application error-prone.

These difficulties may be particularly relevant to multi-process applications due to the existence of process isolation which prevents any single process from accessing memory addresses that are not owned by that process. Therefore, in contrast to threads of a process which share memory space allowing relatively quick and simple communication between threads, separate processes of a multi-process application are isolated from each other and are limited to communicating with each other via defined inter-process communication channels.

For example, within a process, there may be implemented a read/write locking mechanism which controls database accesses. A process can lock itself to access the database and a particular thread of the process starts to write the file-based database, so that other threads within the process temporarily lose the ability of accessing the database. By use of the locking mechanism, the other threads within the process may be able to read the state of the read/write lock and therefore wait until the lock becomes available before attempting to access the database.

However, other processes cannot easily determine the state of the lock placed on the database file and may attempt to read or write to the database leading to that other process receiving an error that the database is locked. There is no inherent mechanism provided in current file-based databases to support preventing multiple processes from writing to a database at the same time other than through file-system locking of the whole file.

FIG. 1 illustrates an example implementation of a Readers-writer lock mechanism for a multi-threaded process. The lock information is implemented in a way that is globally accessible to all the threads of the process, for example within the memory space of the process, a reader lock 102 and a writer lock 104 may be implemented as a flag or mutex primitive. In the example of FIG. 1, in order to prevent one ongoing writer thread from causing errors in other writer threads and reader threads, an application can serialize all database accesses by enforcing the following rules:
a. If a writer thread attempts to access the database, it should acquire the writer lock 104 first. (The writer lock 104 will not be acquired until both writer lock 104 and readers lock 102 are released.)
b. If a reader thread tries to access the database, it should acquire the readers lock 102 first. (The readers lock 102 will not be acquired until the writer lock 104 is released.)

Thus, in the execution sequence illustrated in FIG. 1, two threads performing read accesses are able to obtain the read lock 102 at the same time and execute concurrently. Further threads requesting write access must wait until the read lock 102 has been released before acquiring the write lock 104 and accessing the database.

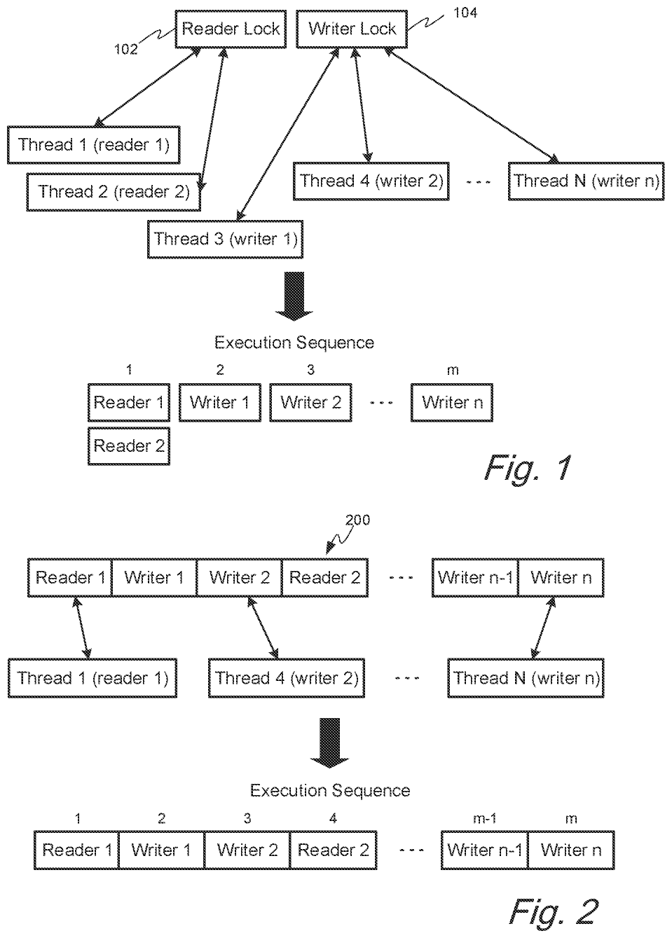

FIG. 2 illustrates an example of a queue mechanism for a multi-threaded process. According to the example of FIG. 2, requests for read/write access to the file-based database are cached to a queue 200 and then allowed to proceed in order one at a time. Thus, one request from the queue 200 to perform an operation on the database is allowed to execute at one time, and any further requests on the queue 200 wait until a current reader/writer thread serving the one request has finished.

This results in all database accesses being serialized, preventing one ongoing writer from causing errors to other writer and reader threads. The queue 200 should be globally accessible to all threads of the process, to allow each thread to determine its place in the execution sequence to perform the requested access to the database.

Both the lock mechanism and queue mechanism require information to be made globally accessible to all entities requesting read/write access to the file-based database. While this is easily achieved for multiple threads of a single process which share the memory space of the process, this is not the case for multi-process applications in which process isolation exists between the different processes of the application. Thus, these simple mechanisms to manage accesses to a file-base database do not support multi-process applications.

Attempting to implement similar arrangement for a multi-process application would involve a mechanism for each process to communicate with the other processes in the application to allow for synchronization of the execution of database operations across the whole application. Any such mechanism may be expected to result in significant duplicated effort when developing each process and increased maintenance effort for the multi-process application.

Certain examples described herein provide a mechanism for managing accesses to a file-based database by processes of a multi-process application. In particular, a mechanism is described whereby a single process of the multi-process application is provided for managing databases accesses for the whole application. Other processes of the multi-process application do not directly interact with the file-based database, but instead request the designated process to execute any database operations and return any result to the requesting process.

In some implementations, a database access module is provided which may be executed as an independent process or incorporated within another process of the multi-process application. The database access module provides database access services to other processes of the application, providing a central controlling entity to manage access to the database and avoid concurrent access attempts that would otherwise result in an error.

The database module may provide a mechanism to prioritize the requested accesses to the database. Furthermore, the database module may identify read requests and write requests received from the other processes and identify read requests that can be executed concurrently.

The database module can be easily incorporated into any multi-process application with any embedded file-based database, such as common desktop applications or mobile apps, facilitating code reuse and reducing development time while reducing the occurrence of errors relating to concurrent accesses to the database.

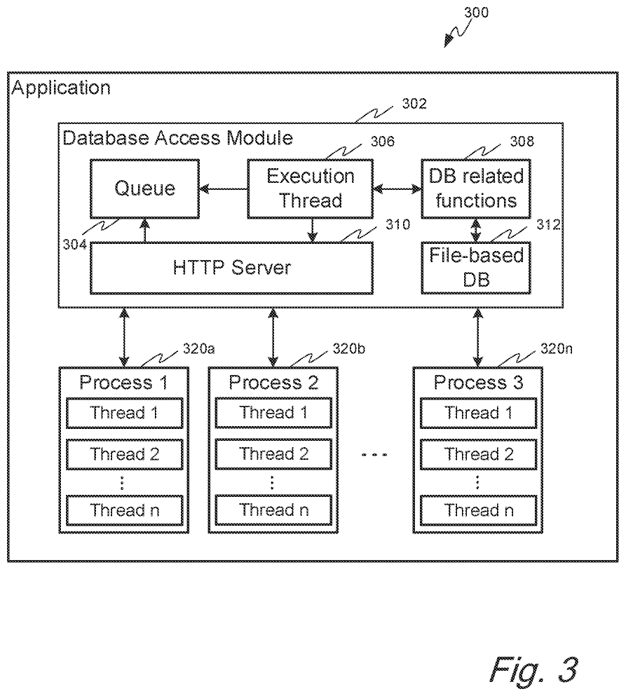

FIG. 3 illustrates a multi-process application 300 including a database access module 302 implemented as an independent process. The database access module 302 includes a queue 304, an execution thread 306, a library of database related functions 308 providing the functions to allow the application to interact with a file-based database, a hyper-text transfer protocol (HTTP) server 310, and the file-based database 312 providing a relational database to store the application data. Other processes 320a, 320b, 320n of the multi-process application 300 that wish to perform a read/write access to the database provide a request to the database module 302 as will be described below.

The HTTP server 310 may provide HTTP handlers to handle all the requests received from the processes 320a, 320b, 320n that want to access the database 312. For example, this may be through Representational State Transfer (REST) Application Programming Interfaces (APIs) which provide a HTTP GET method for read requests, and POST/PUT/DELETE methods for write requests, A HTTP handler will pass a received request to the queue 304 which caches read and write requests in order. The HTTP handler may then be blocked until the request has finished processing. Once the requested action has been completed, the HTTP handler responds to the requesting process 320a with a result of the database operation. In some implementations, timeouts may be specified, and the request may fail if the HTTP handler is blocked for a period that is longer than timeout. A maximum number of requests to be handled by the HTTP server 310 may be configurable for traffic control.

The execution thread 306 operates to retrieve a next request from the queue 304 and then executes the request using the database related functions 308. Requests may be retrieved by the execution thread 306 according to a priority policy and the execution thread 306 may be responsible for prioritizing and serializing the received requests, for example by grouping adjacent read requests in the queue 304 and starting multiple threads to execute the grouped read requests on the file-based database concurrently. The execution thread 306 ensures that only one write request is taken from the queue 304 at one time and starts a single thread to execute that write request exclusively on the file-based database 312.

Thus, the execution thread 306 coordinates the requests cached on the queue 304 such that execution of the cached request to access the database 312 comply with the limitation that only one active write request should be processed on the database 312 at any one time, while the execution of any other read/write requests should wait for until the active write request has been completed. In addition, as noted above read requests may be executed in parallel, improving performance of accesses to the database over a purely serialized model such as the queue-based mechanism of FIG. 2.

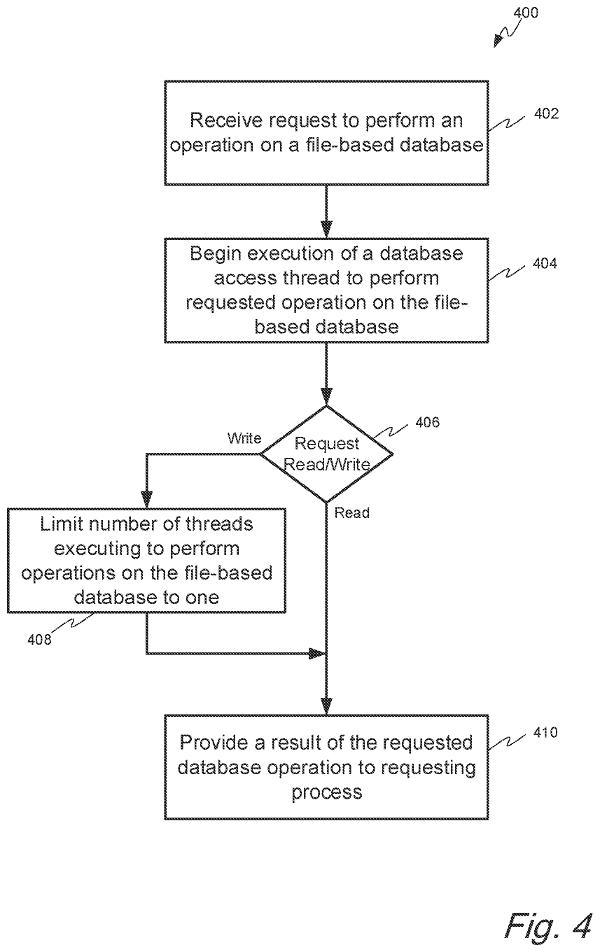

FIG. 4 illustrates a method 400 of managing access to a file-based database. The method 400 may be performed by the database access module 302 of FIG. 3. According to the method of FIG. 4, at block 402 the database access module 302 receives a request to perform an operation on a file-based database. The request may then be cached in queue 304. In response to receiving the request, execution of a database access thread to perform the requested operation on the file-based database is begun 404. A determination 406 is then made to determine whether the request is a read request or a write request. In the case that at the request is a read request, the requested read operation is performed 410 on the database and the result provided to the requesting process. However, if it is determined that the request is a write request the number of threads executing to perform operations on the file-based database is limited 408 to one. Thus, when a thread associated with a write request is executing, no other database access thread to process any further request on the file-based database may be executed.

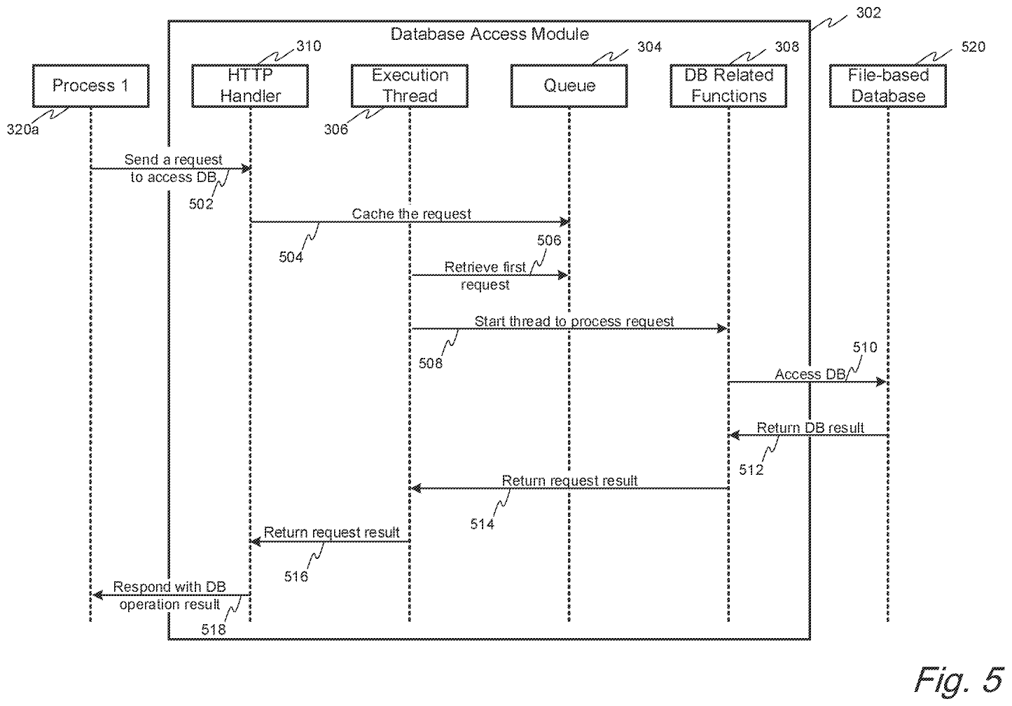

FIG. 5 is a sequence diagram showing an example of processing of a request made by a thread to access the database. In the example shown in FIG. 5, a first process 320a sends a request 502 to access the database to the database access module 302. The request is received by HTTP handler 310 which caches 504 the request on the queue 304.

As discussed above execution thread 306 retrieves 506 requests from the queue 304 according to a priority policy and starts execution 508 of a thread to process the next retrieved request. Using the database related functions provided by library 308 the thread performs the requests operation 510 on the file-based database 520. A result of the database operation is then returned 512, 514 to the execution thread 306 Which passes the result to the HTTP handler 310. The HTTP handler 310 then responds 518 to the first process 320a providing the result of database operation.

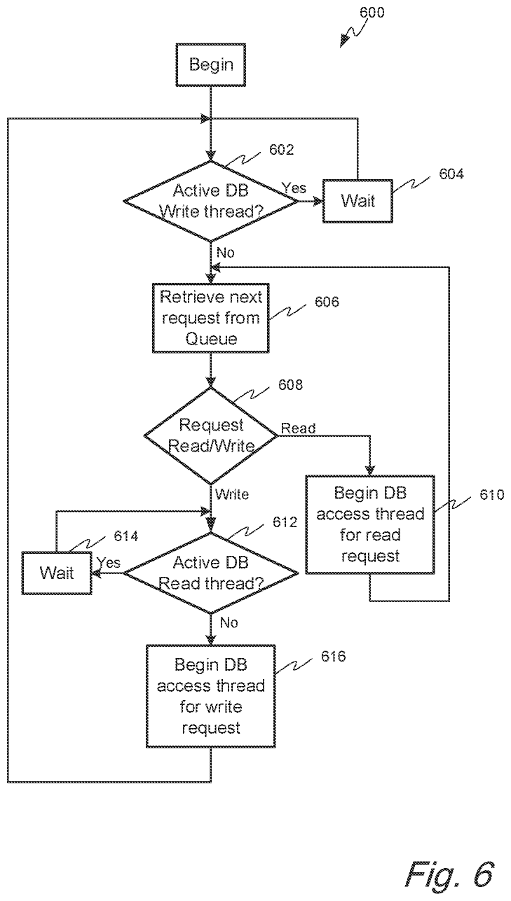

FIG. 6 illustrates a method 600 that may be performed by execution thread 306 to manage access requests to the file-based database 312. According to the method 600 of FIG. 6, a determination 602 is made to determine if there exists an active thread executing a write access to the database 312. In the case that an active write thread exists, the execution thread may wait 604 for a period of time before repeating the determination 602 until it is determined that no active writer thread exists. When it is determined that no active writer thread exists, a next request is retrieved 606 from the queue 304. It is then determined 608 whether the retrieved request is a request for a write access to the database or a request for a read access to the database.

If it is determined that the retrieved request is for a read access to the file-based database 312, a new database access thread is created 610 to process the read request on the database and begins executing. The method 600 then returns to retrieve 606 a further next request from the queue 304.

If it is determined that the retrieved request is for a write access to the file-based database 312, a further determination 612 is made to determine if there exists an active thread executing a read access to the database 312. If it is determined that an active read thread is being executed, the method 600 waits 614 until no active read threads exist. Once it is determined that no active read threads exist, a new database access thread is created 616 to process the write request on the database 312 and begins executing. The method then returns to the beginning to determine 602 when the writer thread has finished executing.

In this way, multiple consecutive read requests in the queue 304 may be processed concurrently as a plurality of database access threads. In addition and/or alternatively, multiple consecutive read requests may be identified in the queue, retrieved together, and corresponding threads spawned to process the requests. In contrast, the method 600 limits the number of threads executing when a write access is being processed to ensure that only one thread is executed at any time when a write access is being performed, avoiding errors due to locking of the file-based database.

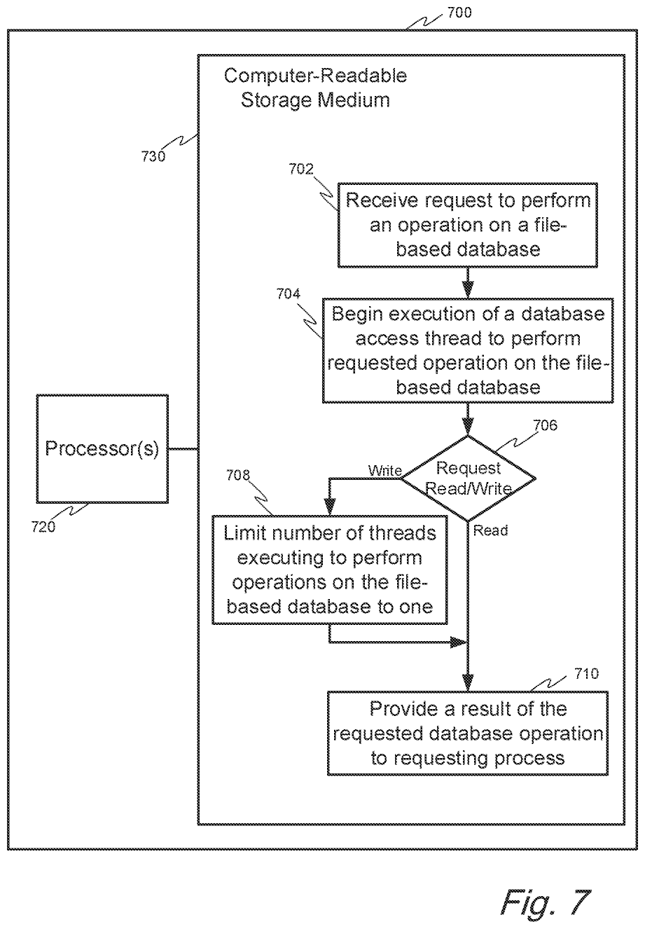

Certain methods and systems as described herein may be implemented by a processor that processes program code that is retrieved from a non-transitory storage medium. In particular, methods 400, 500 and 600 illustrated in FIGS. 4, 5 and 6 may be implemented in the form of computer program code stored on computer readable media and executable by a processor to perform the described methods. FIG. 7 shows an example 700 of a device comprising a computer-readable storage medium 730 coupled to at least one processor 720.

Processors suitable for the execution of computer program code include, by way of example, both general and special purpose microprocessors, application specific integrated circuits (ASIC) or field programmable gate arrays (FPGA) operable to retrieve and act on instructions and/or data from the computer readable storage medium 730.

The computer-readable media 730 may be any media that can contain, store, or maintain programs and data for use by or in connection with an instruction execution system (e.g., non-transitory computer readable media). Computer-readable media can comprise any one of many physical media such as, for example, electronic, magnetic, optical, electromagnetic, or semiconductor media. More specific examples of suitable machine-readable media include, but are not limited to, a hard drive, a random-access memory (RAM), a read-only memory (ROM), an erasable programmable read-only memory, or a portable disc.

In FIG. 7, the computer-readable storage medium comprises program code to when executed on a computing device: receive 702 a request to perform an operation on a file-based database, begin execution 704 of a database access thread to perform the requested operation on the file-based database, determine 706 whether the requested operation is a read or a write access to the database, and if so limit 708 a number of threads executing to perform operations on the file-based database to one; and provide 710 a result of the requested database operation to the requesting process.

In other examples, computer-readable storage medium 730 may comprise program code to perform any of the methods illustrated in FIG. 5 or 6 and discussed above.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings, may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants that fall within the scope of the claims.

### EXAMPLES

According to an example, there is provided a method of accessing a file-based database comprising: receiving, at a first process of a multi-process application, a request from a second process of the multi-process application to perform an operation on a file-based database; in response to receiving the request at the first process, beginning execution of a database access thread to perform the requested operation on the file-based database; and providing, by the first process, a result of the requested operation to the second process; and wherein if the requested operation is a write access to the file-based database, limiting to one a number of threads executing to perform operations on the file-based database while the database access thread to perform the write access is executing.

In an example, the method further comprises storing a plurality of received requests to perform an operation on a file-based database in a request queue; and wherein beginning execution of a database access thread to perform the requested operation further comprises obtaining a first request of the plurality of requests from the request queue and beginning execution of a database access thread to perform the operation of the obtained request.

In an example beginning execution of a database access thread to perform the requested operation of the method further comprises identifying a plurality of consecutive queued requests comprising read accesses to the file-based database; and beginning concurrent execution of a plurality of database access threads to perform the read accesses of the plurality of consecutive requests.

In an example, the method further comprises determining if a database access thread to perform a write access to the file-based database is executing, wherein if it is determined that a database access thread to perform a write access is executing, delaying beginning execution of any further database access threads until the currently executing thread has completed.

In an example, the method further comprises determining if a database access thread to perform a read access to the file-based database is executing, wherein if it is determined that a database access thread to perform a read access is executing, delaying beginning execution of any further database access threads comprising a write access until the currently executing thread has completed.

In an example, receiving, at the first process of the multi-process application, the request from the second process to perform the operation on the file-based database of the method further comprises receiving a HTTP-GET request to perform a read access of the database.

In an example, receiving, at the first process of the multi-process application, the request from the second process to perform the operation on the file-based database of the method further comprises receiving one of a HTTP-POST, HTTP-PUT and HTTP-DELETE request to perform a write access of the database.

In an example of the method, the file-based database comprises an SQLite database.

According to an example, there is provided a non-transitory computer program product for managing access to a file-based database from a plurality of processes of a multi-process application, the computer program product comprising machine-executable instructions arranged, when processed; to: receive, at a first process of the multi-process application, a request from a second process of the multi-process application to perform an operation on the file-based database; in response to receiving the request at the first process, begin execution of a thread to perform the requested operation on the file-based database; and provide, by the first process, a result of the requested operation to the requesting process; and wherein if the requested operation is a write access to the file-based database, limiting to one a number of threads executing to perform operations on the file-based database while the database access thread to perform the write access is executing.

In an example of the computer program product the file-based database comprises an SQLite database.

In an example of the computer program product; the first process comprises: a HTTP server to receive the request from the second process and to provide the request to the second process; a request queue to store a plurality of received requests to be performed on the file-based database; an execution thread to obtain a next requests of the plurality of received requests from the request queue and to begin execution of a database access thread to perform the operation associated with the next request.

In an example of the computer program product, the execution thread is further to obtain from the request queue a plurality of consecutive requests comprising read accesses to the file-based database and begin concurrent execution of a plurality of database access threads to perform the read accesses of the plurality of consecutive requests.

In an example of the computer program product, the execution thread is further to determine if a database access thread to perform a write access to the file-based database is executing, wherein if it is determined that a database access thread to perform a write access is executing, the execution thread to delay execution of any further database access threads until the currently executing thread has completed.

In an example of the computer program product, the execution thread is further to determine if a database access thread to perform a read access to the file-based database is executing, wherein if it is determined that a database access thread to perform a read access is executing, the execution thread to delay beginning execution of any further database access threads comprising a write access until the currently executing thread has completed.

In an example of the computer program product, the HTTP server is further to: receive a HTTP-GET request comprising a request to perform a read access of the database; and store the received read request on the request queue.

In an example of the computer program product, the HTTP server is further to receive one of a HTTP-POST, HTTP-PUT and HTTP-DELETE request to perform a write access of the database; and store the received write request on the request queue.

In an example of the computer program product, the first process further comprises the file-based database.

1. A method of managing access to a file-based database comprising:
receiving, at a first process of a multi-process application, a request from a second process of the multi-process application to perform an operation on a file-based database;
in response to receiving the request at the first process, beginning execution of a database access thread to perform the requested operation on the file-based database; and
providing, by the first process, a result of the requested operation to the second process; and
wherein if the requested operation is a write access to the file-based database, limiting to one a number of threads executing to perform operations on the file-based database while the database access thread to perform the write access is executing.

2. The method of accessing the file-based database of claim 1, further comprising:
storing a plurality of received requests to perform an operation on a file-based database in a request queue; and
wherein beginning execution of a database access thread to perform the requested operation further comprises obtaining a first request of the plurality of requests from the request queue and beginning execution of a database access thread to perform the operation of the obtained request.

3. The method of claim 2, wherein beginning execution of the database access thread to perform the requested operation further comprises:
identifying a plurality of consecutive queued requests comprising read accesses to the file-based database; and
beginning concurrent execution of a plurality of database access threads to perform the read accesses of the plurality of consecutive requests.

4. The method of claim 1, further comprising determining if the database access thread to perform a write access to the file-based database is executing, wherein if it is determined that a database access thread to perform a write access is executing, delaying beginning execution of any further database access threads until the currently executing thread has completed.

5. The method of claim 1, further comprising determining if the database access thread to perform a read access to the file-based database is executing, wherein if it is determined that a database access thread to perform a read access is executing, delaying beginning execution of any further database access threads comprising a write access until the currently executing thread has completed.

6. The method of claim 1, wherein receiving, at the first process of the multi-process application, the request from the second process to perform the operation on the file-based database further comprises receiving a hypertext-transfer protocol HTTP-GET request to perform a read access of the database.

7. The method of claim 6, wherein receiving, at the first process of the multi-process application, the request from the second process to perform the operation on the file-based database further comprises receiving one of a HTTP-POST, HTTP-PUT and HTTP-DELETE request to perform a write access of the database.

8. A non-transitory computer program product for managing access to a file-based database from a plurality of processes of a multi-process application, the computer program product comprising machine-executable instructions arranged, when processed, to:
receive, at a first process of the multi-process application, a request from a second process of the multi-process application to perform an operation on the file-based database;
in response to receiving the request at the first process, begin execution of a database access thread to perform the requested operation on the file-based database; and
provide, by the first process, a result of the requested operation to the second process; and
wherein if the requested operation is a write access to the file-based database, limiting a number of threads executing to perform operations on the file-based database while the database access thread to perform the write access is executing to one.

9. The computer program product of claim 8, wherein the file-based database comprises an SQLite database.

10. The computer program product of claim 8, wherein the first process comprises:
a hypertext transfer protocol (HTTP) server to receive the request from the second process and to provide the request to the second process;
a request queue to store a plurality of received requests to be performed on the file-based database;
an execution thread to obtain a next request of the plurality of received requests from the request queue and to begin execution of the database access thread to perform the operation associated with the next request.

11. The computer program product of claim 10, wherein the execution thread is further to obtain from the request queue a plurality of consecutive requests comprising read accesses to the file-based database and begin concurrent execution of a plurality of database access threads to perform the read accesses of the plurality of consecutive requests.

12. The computer program product of claim 10, wherein the execution thread is further to determine if the database access thread to perform a write access to the file-based database is executing, wherein if it is determined that the database access thread to perform a write access is executing, the execution thread to delay execution of any further database access threads until the currently executing thread has completed.

13. The computer program product of claim 10, wherein the execution thread is further to determine if the database access thread to perform a read access to the file-based database is executing, wherein if it is determined that the database access thread to perform a read access is executing, the execution thread to delay beginning execution of any further database access threads comprising a write access until the currently executing thread has completed.

14. The computer program product of claim 10, wherein the HTTP server is further to:
receive a HTTP-GET request comprising a request to perform a read access of the database; and
store the received read request on the request queue.

15. The computer program product of claim 10, wherein the HTTP server is further configured to receive one of a HTTP-POST request, HTTP-PUT request, and HTTP-DELETE request to perform a write access of the database; and
store the received write request on the request queue.

16. The method of accessing the file-based database of claim 1, wherein the first process creates the database access thread to perform the write access in response to receiving the request from the second process.

17. The method of accessing the file-based database of claim 1, wherein the second process is prevented from accessing memory addresses of the file-based database.

18. The method of accessing the file-based database of claim 1, wherein the first process manages the file-based database for other processes in the multi-process application.

19. The method of accessing the file-based database of claim 18, wherein the other processes of the multi-process application do not directly interact with the file-based database.

20. The method of accessing the file-based database of claim 19, wherein the other processes request the first process to execute database operations and return results to the other processes.
